(19) United States
(12) Patent Application Publication
(10) Pub. No.: US 2025/0014363 A1
(43) Pub. Date: Jan. 9, 2025

(54) VEHICLE IDENTITY RECOGNITION DEVICE AND METHOD USING MACHINE LEARNING

(71) Applicant: HANWHA VISION CO., LTD., Seongnam-si (KR)

(72) Inventors: Byoung Man AN, Seongnam-si (KR); Jin Hyuk Choi, Seongnam-si (KR); Tae Kyung Han, Seongnam-si (KR); Young Bok Kim, Seongnam-si (KR)

(73) Assignee: HANWHA VISION CO., LTD., Seongnam-si (KR)

(21) Appl. No.: 18/895,057

(22) Filed: Sep. 24, 2024

Related U.S. Application Data
(63) Continuation of application No. PCT/KR2022/006412, filed on May 4, 2022.

(30) Foreign Application Priority Data
Apr. 22, 2022 (KR) 10-2022-0050057

(51) Int. Cl. G06V 20/62; G06V 10/25; G06V 10/82; G06V 30/14

(52) U.S. Cl. CPC G06V 20/625; G06V 10/25; G06V 10/82; G06V 30/14; G06V 2201/08

(57) ABSTRACT

A vehicle identity recognition device includes: a data input interface configured to receive a first image of a first vehicle and a second image of a second vehicle; and at least one processor configured to control: a region of interest extractor to extract a first region of interest from the first image and extract a second region of interest from the second image corresponding to the first region of interest, the first region of interest and the second region of interest being partial regions of a vehicle including a vehicle license plate; a machine learner to perform machine learning by inputting the first region of interest as training data; and an image matcher to determine whether the first region of interest on which the machine learning is performed matches the second region of interest.

### CROSS-REFERENCE TO RELATED APPLICATION(S)

This application is a continuation of International Application No. PCT/KR2022/006412, filed on May 4, 2022, in the Korean Intellectual Property Receiving Office, which is based on and claims priority to Korean Patent Application No. 10-2022-0050057, filed on Apr. 22, 2022, in the Korean Intellectual Property Office, the disclosures of which are incorporated by reference herein in their entireties.

### BACKGROUND

### 1. Field

The present disclosure relates to technology for recognizing vehicle identity using machine learning, and more particularly, to a device and method for determining whether a currently imaged vehicle is a registered vehicle with the same vehicle license plate and determining whether to block entry or exit of the vehicle accordingly.

### 2. Description of Related Art

Recently, automated parking management systems that allow a vehicle to enter or exit by determining whether the vehicle entering a facility, such as a building or apartment complex, is a registered vehicle within the facility are widely used. As such, Automatic Number-Plate Recognition (ANPR) technology, which recognizes a vehicle's license plate, is commonly used to determine whether the currently entering vehicle is a registered vehicle.

However, in order to bypass the parking management system, cases of abuse have been frequently discovered in which vehicle license plates identical to those of vehicles registered within the facility are forged and attached to vehicles. A typical parking management system extracts a license plate portion from a vehicle image, recognizes the extracted license plate portion through optical character recognition (OCR), and determines whether the recognized number is a registered number. Therefore, if the vehicle license plate is forged and attached to the vehicle, the conventional parking management system is unable to process that the vehicle is not a registered vehicle, and allows the vehicle to enter or exit.

Recently, a recognition rate of the vehicle license plate has been improved due to the development of so-called deep learning-based artificial intelligence technology. However, since such artificial intelligence technology is still focused only on recognizing the vehicle number itself, there is a limitation in filtering out the vehicle with the forged license plate as described above. Therefore, there is a need for the development of vehicle identity recognition technology that may filter out the vehicle with the forged vehicle license plate as an unregistered vehicle.

### SUMMARY

Aspects of the present disclosure are to block vehicles with forged license plates from entering to or exiting from the facility by considering not only a vehicle license plate but also image characteristics of the vehicle.

However, aspects of the present invention are not restricted to those set forth herein. The above and other aspects will become more apparent to one of ordinary skill in the art to which the disclosure pertains by referencing the detailed description of the present invention given below.

According to an aspect of the disclosure, a vehicle identity recognition device may include: a data input interface configured to receive a first image of a first vehicle and a second image of a second vehicle; and at least one processor configured to control: a region of interest extractor to extract a first region of interest from the first image and extract a second region of interest from the second image corresponding to the first region of interest, the first region of interest and the second region of interest being partial regions of a vehicle including a vehicle license plate; a machine learner to perform machine learning by inputting the first region of interest as training data; an image matcher to determine whether the first region of interest on which the machine learning is performed matches the second region of interest; a license plate identifier to identify whether a license plate of the first vehicle is identical to a license plate of the second vehicle; and a controller to recognize the second vehicle as an identical vehicle based on the first region of interest matching the second region of interest and the license plate of the first vehicle being identical to the license plate of the second vehicle.

The at least one processor may be further configured to control: a weight applier to apply different weights to each of a vehicle license plate area and a vehicle license plate external region for at least one of the first region of interest and the second region of interest.

A first weight may be applied to the vehicle license plate area and a second weight, higher than the first weight, may be applied to the vehicle license plate external region.

The at least one processor may be further configured to control: an image scrambler to apply an artificial image change to at least one of the first region of interest and the second region of interest, and where the artificial image change includes one or more of an image brightness change, a contrast change, a blur change, and image tampering.

The at least one processor may be further configured to control: a feature point extractor to extract feature points for each of the extracted first region of interest and the extracted second region of interest, the machine learner to perform the machine learning based on the extracted feature points as input, and the image matcher to determine whether the regions of interest are matched based on the extracted feature points.

The license plate of the first vehicle may be a value input by a user, where the at least one processor is further configured to control the license plate identifier to: recognize the license plate of the second vehicle by OCR, and determine whether the license plate of the second vehicle matches the license plate of the first vehicle.

The at least one processor may be further configured to control the license plate identifier to: convert a license plate included in the first region of interest and a license plate included in the second region of interest into a frontal image, and determine whether the license plate of the second vehicle matches the license plate of the first vehicle.

The at least one processor may be further configured to control the license plate identifier to: recognize at least one of a font, an aspect ratio, and a blank ratio of the license plate included in the first region of interest and the license plate included in the second region of interest.

The at least one processor may be further configured to control the image matcher to: convert the first region of interest on which the machine learning is performed and the second region of interest into images of a same angle, and determine whether the converted images match.

The at least one processor may be further configured to control: based on a matching probability between the first region of interest on which the machine learning is performed and the second region of interest being greater than or equal to a reference value, the image matcher to determine that the first region of interest matches the second region of interest.

The machine learning may be at least one of supervised learning and unsupervised learning.

The at least one processor may be further configured to control the machine learner to perform machine learning by inputting the first region of interest as training data for each of three color components.

The data input interface may be further configured to repeatedly receive the first image of the first vehicle a predetermined number of times.

The at least one processor may be further configured to control: based on a time at which the first vehicle is recognized by a specific camera and a second time at which the second vehicle is recognized by the specific camera being within a predetermined threshold, the controller to recognize the first vehicle and the second vehicle as different vehicles.

The at least one processor may be further configured to control an entry or an exit of the second vehicle based on whether the second vehicle is recognized as the identical vehicle.

According to an aspect of the disclosure, a vehicle identity recognition method performed by a vehicle identity recognition device including at least one processor and a memory that stores instructions executable by the at least one processor, the vehicle identity recognition method may include: receiving a first image of a first vehicle and a second image of a second vehicle; extracting a first region of interest from the first image; extracting a second region of interest from the second image corresponding to the first region of interest, the first region of interest and the second region of interest being partial regions of a vehicle including a vehicle license plate; performing machine learning by inputting the first region of interest as training data; determining whether the first region of interest on which the machine learning is performed matches the second region of interest; identifying whether a license plate of the first vehicle is identical to a license plate of the second vehicle; and recognizing the second vehicle as an identical vehicle based on the first region of interest matching with the second region of interest and the license plate of the first vehicle being identical to the second vehicle.

The method may further include: applying different weights to each of a vehicle license plate area and a vehicle license plate external region for at least one of the first region of interest and the second region of interest.

The method may further include: applying a first weight to the vehicle license plate area and applying a second weight higher than the first weight to the vehicle license plate external region.

The method may further include: applying an artificial image change to at least one of the first region of interest and the second region of interest, where the artificial image change includes one or more of an image brightness change, a contrast change, a blur change, and image tampering.

The method may further include: extracting feature points from each of the first region of interest and the second region of interest.

The method may further include: controlling entry or exit of the second vehicle based on whether the second vehicle is recognized as the identical vehicle.

According to an aspect of the disclosure, a vehicle identity recognition device may include: a data input interface configured to receive a first image of a first vehicle and a second image of a second vehicle; and at least one processor configured to control: a region of interest extractor to extract a first region of interest from the first image and extract a second region of interest from the second image corresponding to the first region of interest, the first region of interest and the second region of interest being partial regions of a vehicle including a vehicle license plate; an image matcher to determine whether the first region of interest matches the second region of interest; a license plate identifier to identify whether a license plate of the first vehicle is identical to a license plate of the second vehicle; and a controller to recognize the second vehicle as the identical vehicle based on the first region of interest matching the second region of interest and the license plate of the first vehicle being identical to the license plate of the second vehicle.

The at least one processor may be further configured to control entry or exit of the second vehicle based on whether the second vehicle is recognized as the identical vehicle.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a configuration of a vehicle license plate recognition system according to an embodiment of the present disclosure;

FIG. 2 is a diagram illustrating how a vehicle is registered by a vehicle management server according to an embodiment of the present disclosure;

FIG. 3 is a block diagram illustrating a configuration of a vehicle management server according to an embodiment of the present disclosure;

FIG. 4 is a block diagram illustrating a configuration of a vehicle identity recognition device according to an embodiment of the present disclosure;

FIG. 5A illustrates a full image of a vehicle according to an embodiment of the present disclosure;

FIG. 5B illustrates a region of interest of the vehicle extracted from the full image of FIG. 5A according to an embodiment of the present disclosure;

FIG. 6A illustrates a full image of a vehicle according to an embodiment of the present disclosure;

FIG. 6B illustrates a region of interest of the vehicle extracted from the full image of FIG. 6A according to an embodiment of the present disclosure;

FIG. 7A, FIG. 7B, FIG. 7C and FIG. 7D illustrate examples of vehicle license plates that have the same text but are actually different from each other;

FIG. 8A, FIG. 8B, FIG. 8C, and FIG. 8D are diagrams illustrating examples of artificial image variation applied to a vehicle image;

FIG. 9A is a block diagram of the machine learning unit of the vehicle identity recognition device in FIG. 4 according to an embodiment of the present disclosure;

FIG. 9B is an example of a deep neural network (DNN) model which can be used for the machine learning unit according to an embodiment of the present disclosure;

FIG. 10 is a block diagram illustrating the hardware configuration of a computing device that implements a vehicle identity recognition device according to an embodiment of the present disclosure; and

FIG. 11 is a flowchart schematically illustrating a vehicle identity recognition method performed by a vehicle identity recognition device according to an embodiment of the present disclosure.

### DETAILED DESCRIPTION

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise,” “include,” “have,” and variations such as “comprises,” “comprising,” etc. will be understood to imply the inclusion of stated elements but not the exclusion of any other elements.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

Hereinafter, exemplary embodiments of the present disclosure will be described in detail with reference to the accompanying drawings.

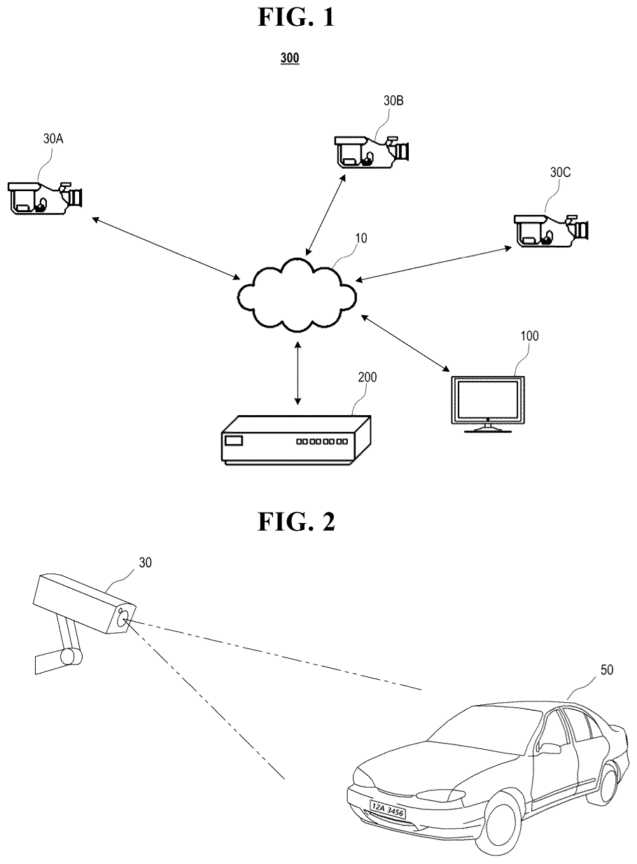

FIG. 1 is a diagram illustrating a configuration of a vehicle license plate recognition system 300 according to an embodiment of the present disclosure. Referring to FIG. 1, the system 300 may be configured to include a vehicle management server 200 that captures images from one or more cameras 30 (30A, 30B, and 30C) and controls operations of the cameras 30 (30A, 30B, and 30C), and a vehicle identity recognition device 100 that may be linked to the vehicle management server 200 in a communication state.

The one or more cameras 30A, 30B, and 30C, the vehicle management server 200, and the vehicle identity recognition device 100 may be connected to each other through a network 10 such as the Internet or an intranet. The vehicle identity recognition device 100 may be implemented as a personal computer, mobile terminal device, etc., and the vehicle management server 200 may be a server device installed in a facility such as an apartment or building that controls an entry or exit of a vehicle and monitors parking conditions. The one or more cameras 30A, 30B, and 30C may be connected to the vehicle management server 200 through the network or may be mounted on the vehicle management server 200.

The vehicle management server 200 may provide data such as registration-related information of a vehicle, a registered vehicle image, and a vehicle image captured by a camera to the vehicle identity recognition device 100, and may control entry and exit of the vehicle based on vehicle identity determined by the vehicle identity recognition device 100. That is, the vehicle management server 200 may allow passage when a vehicle identical to the registered vehicle enters or exits and may block passage when a vehicle different from the registered vehicle enters or exits. In the present disclosure, the meaning of “image” is a concept that encompasses still images and moving images, and “identical vehicle” means a vehicle of substantially the same model and color as the vehicle registered at the facility, as well as having the same vehicle license plate. Accordingly, a vehicle with a vehicle license plate that has been forged and altered to look the same as the registered vehicle is not the “same vehicle” in the present disclosure. In order to filter out the vehicle with such forged and altered vehicle license plate, the present disclosure may determine whether it is the “identical vehicle” by determining not only identity of a vehicle license plate but also whether or not the region of interest (ROI) image of the vehicle including the vehicle license plate matches.

FIG. 2 is a diagram illustrating how a vehicle 50 is registered by the vehicle management server 200. In general, the vehicle 50 may be constantly captured by the camera 30 installed at various positions within the facility, such as an entrance to a parking lot. Through such a process, the vehicle 50 may be easily registered within the facility without a separate image recording process. For example, new residents of certain facilities may submit images of their vehicles in a process of filling out bibliographic information such as personal information, vehicle model, and vehicle number for registering their vehicles. However, just by submitting the bibliographic information, when the vehicle model and vehicle number recognized by the camera 30 within the facility match the bibliographic information, the image of the vehicle may be automatically registered. In order to prevent errors, the vehicle may be automatically registered normally when a vehicle matching the bibliographic information is detected more than a predetermined number of times within the complex.

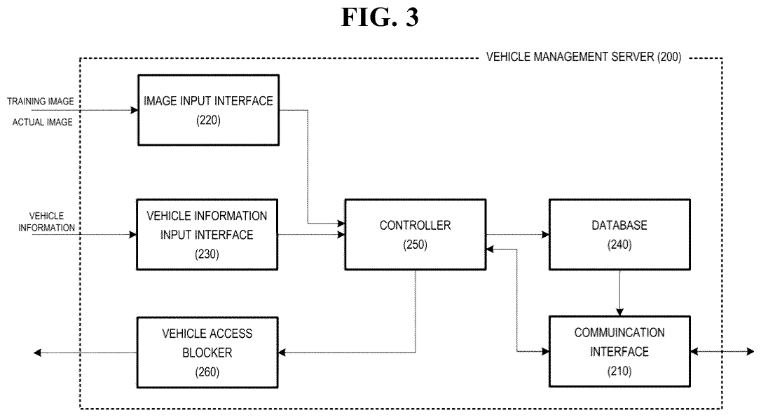

FIG. 3 is a block diagram illustrating a configuration of a vehicle management server 200 according to an embodiment of the present disclosure.

The vehicle management server 200 may be configured to include a communication interface 210, an image input interface 220, a vehicle information input interface 230, a database 240, a controller 250, and a vehicle access blocker 260.

The controller 250 may serve as a controller to control the operations of other components of the vehicle management server 200, and may generally be implemented with a central processing unit (CPU), a microprocessor, or the like. In addition, a memory (not illustrated) is a storage medium that stores results performed by the controller 250 or data necessary for the operation of the controller 250, and may be implemented as a volatile memory or a non-volatile memory.

The image input interface 220 may capture a training image (first image) and an actual image (second image), and store the images as image signals (digital data). The image input interface 220 may include a capturing element such as CCD or CMOS, and may be mounted on the vehicle management server 200 separately from the camera 30 of FIGS. 1 and 2. However, the present disclosure is not limited thereto and the vehicle management server 200 may not be equipped with the capturing element, and the image input interface 220 may receive an image from the camera 30 through the communication unit 210.

The vehicle information input interface 230 may be configured with a user interface such as a touch panel, and receive vehicle information that a facility's user inputs to register his or her vehicle. Such vehicle information may include personal information, vehicle model, vehicle number, etc. The images input to the image input interface 220 and the vehicle information input to the vehicle information input interface 230 may be stored and managed in a database 240.

The communication interface 210 may support a communication protocol to communicate with other cameras 30 and/or the vehicle identity recognition device 100 over a network, regardless of whether it is a wired or wireless interface. The vehicle image and vehicle information stored in the database 240 may be provided to the vehicle identity recognition device 100 through the communication interface 210. In addition, the communication interface 210 may receive a vehicle identity determination result from the vehicle identity recognition device 100 and provide it to the controller 250.

The controller 250 may control an operation of the vehicle access blocker 260 based on the vehicle identity determination result. For example, when a vehicle whose identity is not recognized (e.g., an unregistered vehicle), enters, the controller 250 may control the vehicle access blocker 260 to close and generate an alarm. When a vehicle whose identity is recognized enters, the controller 250 may control the vehicle access blocker 260 to open.

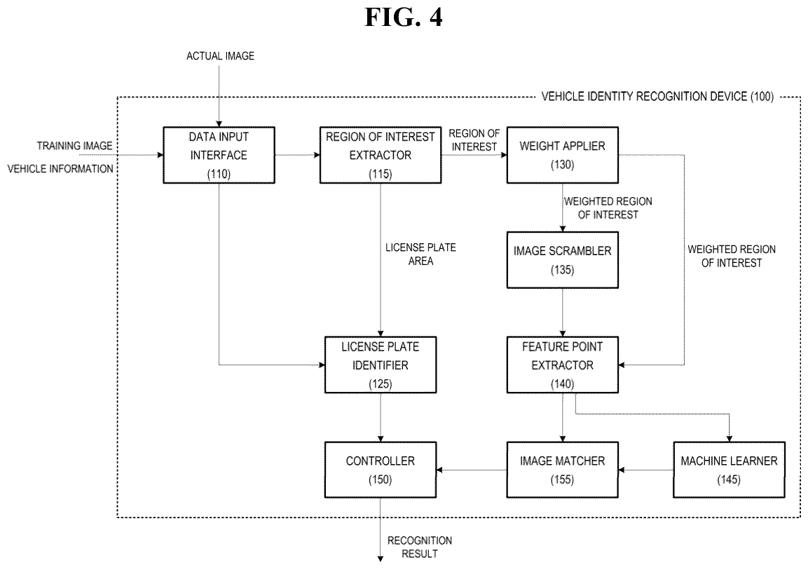

FIG. 4 is a block diagram illustrating a configuration of a vehicle identity recognition device 100 according to an embodiment of the present disclosure. The vehicle identity recognition device 100 may include a controller 150 and a memory that stores instructions executable by the controller 150. The controller 150 may control the operations of other components of the vehicle identity recognition device 100, and may generally be implemented with a central processing unit (CPU), a microprocessor, or the like. In addition, a memory may be a storage medium that stores results performed by the controller 150 or data necessary for the operation of the controller 150, and may be implemented as a volatile memory or a non-volatile memory.

The vehicle identity recognition device 100 may be configured to include a data input interface 110, a region of interest extractor 115, a machine learner 145, an image matcher 155, and a license plate identifier 125, in addition to the controller 150.

The data input interface 110 may receive a first image including a first vehicle and a second image including a second vehicle. The first vehicle may be a registered vehicle, and the first image may be an image of the registered vehicle that is a subject of learning. In addition, the second vehicle may be a vehicle captured by a camera, and the second image may be an actual image (current image) of the learned registered vehicle and the captured vehicle. The data input interface 110 may receive vehicle information of the first vehicle, a first image, and a second image from the communication interface 210 of the vehicle management server 200. The vehicle information refers to information related to the registered vehicle, such as a vehicle model and a vehicle number.

The first image may be an image repeatedly captured a predetermined number of times for the registered first vehicle. Repeatedly capturing the first image may secure sufficient training data to classify vehicle images for identity through machine learning. In addition, the first image may include an image of an actually registered vehicle, but may further include an image of another vehicle of the same vehicle model as the registered vehicle because the image of the vehicle, excluding the vehicle license plate, is the same for the same vehicle model. Increased amounts of training data for machine learning may increase the accuracy of machine learning. In addition, when using a black and white image, a color may not matter as long as the vehicle is of the same model, but when using color images, vehicles of the same model, with different colors may be classified as different vehicles.

The region of interest extractor 115 may extract a first region of interest for the input first image and extract a second region of interest for the second image corresponding to the first region of interest. Here, the first region of interest and the second region of interest may include at least a vehicle license plate. As described above, the present disclosure may account for the fact that vehicles with forged or altered license plates may not be filtered out using only the vehicle license plate. Thus, one or more embodiments may use not only the vehicle license plate information but also image information obtained by capturing a vehicle's exterior. However, if the entire vehicle is targeted, the accuracy may decrease as the complexity of machine learning increases. Therefore, the region of interest in the present disclosure refers to an image of a partial region of the vehicle that includes at least the vehicle license plate. Therefore, the region of interest is divided into a vehicle license plate area and a vehicle license plate external region.

The region of interest extractor 115 may first detect the vehicle license plate area in the image including the vehicle, and cause the license plate identifier 125 to recognize the license plate in the detected region. Thereafter, the region of interest extractor 115 may extract a region of interest including the vehicle license plate area as a portion (e.g., a central portion). As described above, when only the region of interest is automatically extracted rather than the full image of the vehicle, and machine learning is applied only to the region of interest (i.e., only to a preprocessed input image), this may have the effect of reducing complexity in the machine learning process and improving the accuracy of learning results.

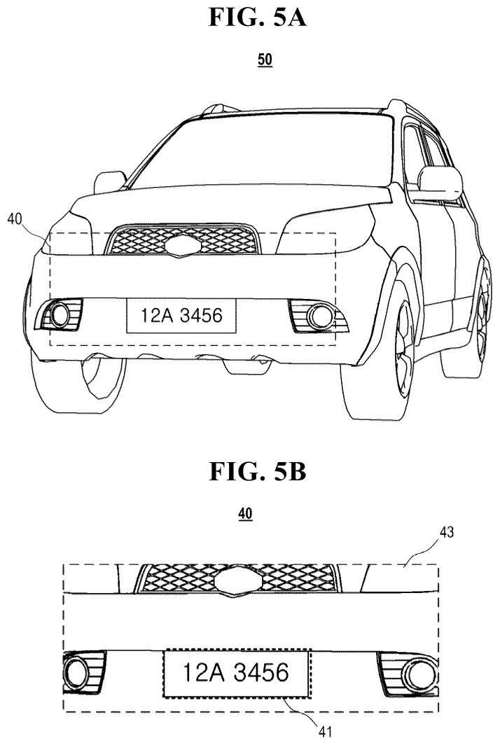

FIG. 5A illustrates a full image 50 of a vehicle according to an embodiment of the present disclosure, and FIG. 5B illustrates a region of interest 40 of the vehicle extracted from the full image 50 of FIG. 5A. As illustrated in FIG. 5A, the region of interest 40 is a partial image of the vehicle that includes at least a vehicle license plate area 41 of the full vehicle image 50. The criteria for setting such a region of interest 40 may vary, but the region of interest 40 may include headlights, grille, bumper shapes, etc. that reveal characteristics of the vehicle. The region of interest 40 may be obtained, for example, by applying a multiple to the up, down, left, and right sides based on a size of the vehicle license plate area 41. The multiple may be the same value in the up, down, left, and right sides, but may have different values in the up, down, left, and right sides so that more portions that clearly reveal the characteristics of the vehicle may be included, as illustrated in FIG. 5B. As a result, the region of interest 40 may include a vehicle license plate area 41 and a vehicle license plate external region 43. In general, since the vehicle license plate is a portion where contamination is minimized even in poor driving environments (e.g., dusty roads, snowy/rainy weather, etc.), a vehicle region adjacent to the vehicle license plate may also be less likely to be contaminated, which may reduce errors when recognizing the identity of the vehicle.

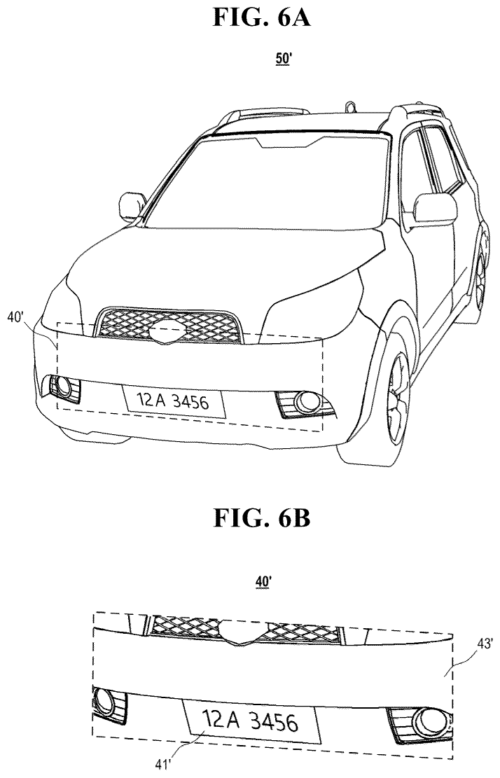

FIG. 6A illustrates a full image 50′ of a vehicle according to another embodiment of the present disclosure, and FIG. 6B illustrates a region of interest 40′ of the vehicle extracted from the full image 50′ of FIG. 6A. Unlike FIG. 5A, FIG. 6A is the same vehicle image, but a capturing angle is different. Therefore, the extracted region of interest may also be skewed in a predetermined direction, as illustrated in FIG. 6B. However, when the multiples applied to the up, down, left, and right sides are the same as in FIG. 5B, even the skewed region of interest 40′ as illustrated in FIG. 6B may correspond to the region of interest 40 illustrated in FIG. 5B in a one-to-one manner. That is, a vehicle license plate area 41′ of FIG. 6B may correspond to the vehicle license plate area 41 of FIG. 5B in a one-to-one manner, and a vehicle license plate external region 43′ of FIG. 6B may correspond to the vehicle license plate external region 43 of FIG. 5B in a one-to-one manner. According to such correspondence, a skewed image as illustrated in FIG. 6B may be converted to a frontal image as illustrated in FIG. 5B.

Referring again to FIG. 4, the machine learner 145 may perform machine learning by inputting the first region of interest for the first vehicle as training data. Such machine learning may be supervised learning, but may also be unsupervised learning. The supervised learning may be a method of increasing the accuracy of machine learning by repeating a process of labeling an image for which a user's correct answer (e.g., a specific vehicle model) is known, allowing artificial intelligence (AI) to perform machine learning, and feeding back the labeling results to the machine learning results, allowing the AI to change AI parameters (network parameters).

In comparison, the unsupervised learning may be a method in which AI performs learning on its own without a user labeling process, and may require much more learning data and learning process than the supervised learning. To this end, the unsupervised learning may be a method in which AI constructs and learns a network on its own by inputting a large amount of learning data, including not only normal images but also intentionally variable or distorted images.

The region of interest for machine learning may include of one channel image in the case of a black and white image, and three channel images (R/G/B) in the case of a color image. Therefore, the first region of interest that is the subject of learning may include three for each channel. However, in this case, the complexity of machine learning may increase due to the increase in channels, but since vehicles of different colors may be identified, the accuracy of determining vehicle identity may be increased.

The image matcher 155 may determine whether the first region of interest on which the machine learning was performed matches the second region of interest. The image matcher 155 may convert the first region of interest of the first vehicle on which the machine learning was performed and the second region of interest of the second vehicle into images of the same angle and then determine whether the images match each other. If FIGS. 5A and 5B are images of the first vehicle and the second vehicle, respectively, the image of the second region of interest of the second vehicle may be converted into a frontal image through angle conversion and then compared with the image of the first region of interest.

The process by which the image matcher 155 recognizes the second region of interest for image matching also goes through the same process as the machine learning for learning described above. That is, the image matcher 155 may perform deep learning inference by applying the AI parameters (network parameters) obtained in the learning process to the second region of interest, and as a result of the inference, the second region of interest matches the first region of interest, and the matching result may be expressed as a probability or percentage.

Therefore, when a matching probability between the first region of interest on which the machine learning was performed and the second region of interest is greater than or equal to a reference value (e.g., 80%), the image matcher 155 may determine that the first region of interest and the second region of interest are matched.

The license plate identifier 125 may identify whether the license plate of the first vehicle and the license plate of the second vehicle are the same. As an embodiment, the license plate of the first vehicle may be a value (text including numbers) entered by the user, and the license plate identifier 125 may recognize the license plate of the second vehicle using various recognition algorithms and then determine whether the license plate of the second vehicle matches the license plate of the first vehicle. As the recognition algorithm, various methods such as various object detection algorithms, optical character recognition (OCR) algorithms, and convolutional neural network (CNN) may be used.

As another embodiment, the license plate identifier 125 may convert the license plate included in the first region of interest and the license plate included in the second region of interest into a frontal image, and may then determine whether the license plates match from the image itself through the machine learning as described above. In this case, the license plate identifier 125 may perform recognition by additionally considering the font, aspect ratio, and blank ratio between the license plate included in the first region of interest and the license plate included in the second region of interest, and may match the recognized results.

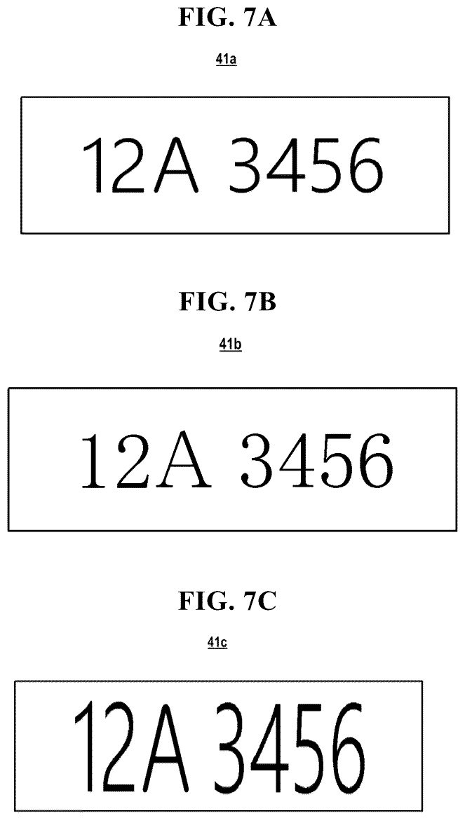

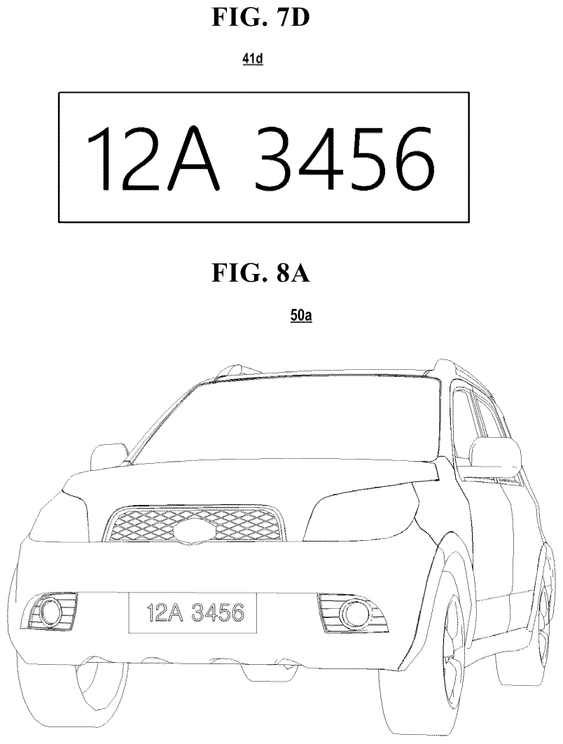

FIGS. 7A to 7D illustrate examples of vehicle license plates that have the same text but are actually different from each other. The texts of the vehicle license plates in FIGS. 7A to 7D are the same as “12-ga 3456.” If FIG. 7A illustrates a license plate of an actually registered vehicle, even the vehicles with the license plates as illustrated in FIGS. 7B to 7D will be recognized as the same license plate from the perspective of OCR. However, in an embodiment of the present disclosure, since the license plate identifier 125 compares the license plates through machine learning of the image itself rather than OCR, the license plate identifier 125 may determine that the license plate of FIG. 7A and the license plate of FIGS. 7B to 7D are different. In particular, using supervised learning, AI may be trained with the license plates of FIGS. 7B to 7D that are different from the license plate of FIG. 7A.

For example, since the license plate 41a of FIG. 7A has a different font from the license plate 41b of FIG. 7B, the license plate identifier 125 may identify both as different license plates.

In addition, since the license plate 41a of FIG. 7A has the same font as the license plate 41c of FIG. 7C, but has a different aspect ratio, the license plate identifier 125 may identify both as different license plates.

In addition, since the license plate 41a of FIG. 7A has the same font as the license plate 41c of FIG. 7C, but has a blank of a different size compared to the outline of the license plate, the license plate identifier 125 may identify both as different license plates.

As such, the license plate identifier 125 may consider not only the text of the license plate but also attributes of the license plate, and determine that the license plates are different even if the text is the same when the attributes are different. Even if the attributes are the same, if the text is different, the license plates may be naturally determined as different license plate.

Referring again to FIG. 4, when the first region of interest of the first vehicle and the second region of interest of the second vehicle match each other, and the license plate of the first vehicle and the license plate of the second vehicle are identified as being identical, the controller 150 may recognize the first vehicle and the second vehicle as the identical vehicle and provide the recognition result to the vehicle management server 200. Therefore, when the regions of interest do not match each other or the license plates are identified as being different, the controller 150 may recognize the first vehicle and the second vehicle as different vehicles.

When determining whether the first vehicle and the second vehicle are identical, the controller 150 may consider the time at which the vehicles were recognized. For example, if the first vehicle enters the facility and the second vehicle enters the facility within a predetermined time (e.g., when it is not enough time for the same vehicle to enter again), the controller 150 may determine that the vehicles are different regardless of whether the vehicles are identical. Alternatively, as another example, even when the first vehicle enters the facility and the second vehicle enters the facility while the first vehicle does not exit, the controller 150 may determine that the vehicles are different regardless of whether the vehicles are identical.

The vehicle identity recognition device 100 may further include a weight applier 130, an image scrambler 135, and a feature point extractor 140 in addition to the components described above.

The weight applier 130 may apply different weights to each of the vehicle license plate area and the vehicle license plate external region for at least one of the first region of interest and the extracted second region of interest extracted by the region of interest extractor 115. For example, the weight applier 130 may apply a relatively low weight to the vehicle license plate area and apply a relatively high weight to the vehicle license plate external region. In an extreme case, the weight applier 130 may apply a weight of 0 to the license plate area and a weight of 1 to the license plate external region. In this case, the license plate area may be set to have no edge data except the outline. The reason for lowering the weight for the vehicle license plate area is that the identity of the license plate may be separately determined by the license plate identifier 125, and by removing the license plate, the complexity caused by the license plate may be reduced during machine learning and matching of the first and second regions of interest, and errors caused by mistaking the license plate as a unique feature point of the vehicle may be removed.

In addition, the image scrambler 135 may apply artificial image changes to the extracted or weighted regions of interest. The artificial image change may include one or more of an image brightness change, a contrast change, a blur change, and image tampering. Such an image variation may contribute to greatly increasing the number of training data when applying machine learning. In the case of the unsupervised learning described above, a very large amount of training data may be required, and in reality, since the number of training data is limited, a large number of training data may be secured through such image variation.

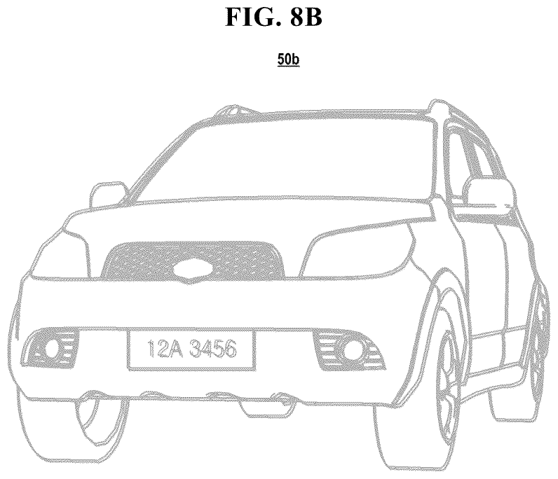

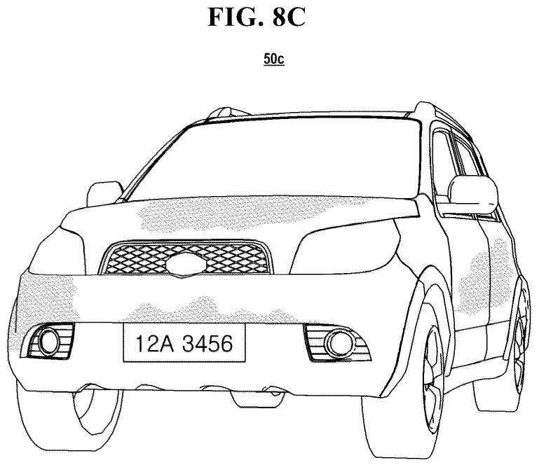

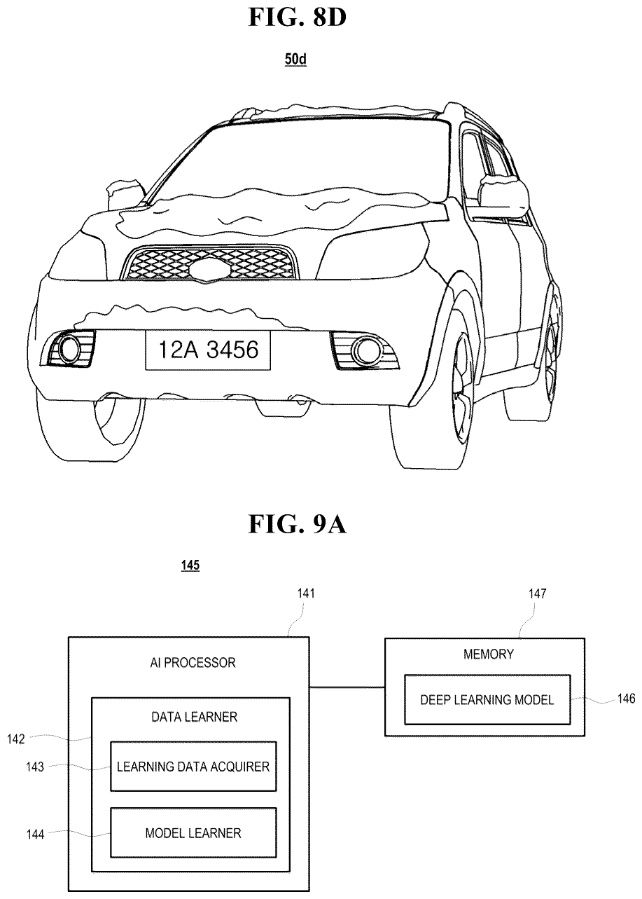

FIG. 8A illustrates an image with brightness adjusted from the vehicle image of FIG. 5A, and FIG. 8B illustrates an image in which blur has been added to the vehicle image of FIG. 5A. In addition, FIGS. 8C and 8D illustrate images in which tampering or distortion has been applied to the vehicle image of FIG. 5A. The vehicle image of FIG. 8C may affect machine learning of a vehicle that is dirty due to dust or dirt, and the vehicle image of FIG. 8D may affect machine learning of a snow-covered vehicle.

In the above, it is described that the identity of the vehicle may be determined through machine learning without extracting separate feature points from the vehicle image. However, the present disclosure is not limited thereto, and it may also possible to determine the identity of the vehicle based on a binarized image in which feature points are extracted from the vehicle image. According to an embodiment of the present disclosure, the feature point extractor 140 may extract feature points for each of the extracted first region of interest and the extracted second region of interest. The feature points refer to edge data of the image portion that may represent the characteristics of the vehicle, and may include a vehicle's radiator grill, a vehicle's headlight, and a vehicle's pillar line. Such vehicle feature points may be vehicle-specific elements that correspond to the shape and spacing of both eyes, nose, and mouth used in a face recognition algorithm.

In this way, when the feature point extractor 140 is used, the machine learner 145 may perform the machine learning using the extracted feature points as input, and the image matcher 155 may determine whether the regions of interest are matched based on the extracted feature points.

In the above-described embodiments, it is described that the image matching is performed using the machine learning. However, the present disclosure is not limited thereto, and the image matcher 155 may also perform the image matching using an algorithm (e.g., KAZE, AKAZE, ORB, etc.) that compares the extracted feature points without machine learning. Since the functions and operations of the data input interface 110, the region of interest extractor 115, the license plate identifier 125, and the controller 150 other than the image matcher 155 are the same as those in the embodiment of FIG. 4, duplicate descriptions will be omitted.

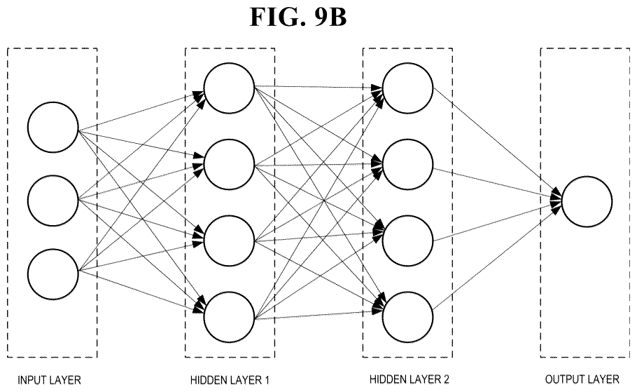

FIG. 9A is a block diagram of the machine learner 145 of the vehicle identity recognition device 100 in FIG. 4, and FIG. 9B is an example of a deep neural network (DNN) model which can be used for the machine learner 145. Such machine learner 145 may be included within the vehicle identity recognition device 100 as shown in FIG. 4, but may also exist on a separate external server.

The machine learner 145 may include an AI processor 141 and a memory 147.

The AI processor 141 may learn a neural network by using a program stored in the memory 147. The AI processor 141 may learn a neural network for recognizing training data. Here, the neural network for recognizing training data may be designed to simulate a human brain structure on a computer, and may include a plurality of network nodes with weights that simulate neurons of the human neural network.

The plurality of network modes may exchange data according to their respective connection relationships such that neurons may simulate the synaptic activity of neurons for sending and receiving signals through synapses. Here, the neural network may include a deep learning model developed from a neural network model. In the deep learning model, a plurality of network nodes may be located in different layers and exchange data according to a convolutional connection relationship. Examples of neural network models include various deep learning techniques, such as deep neural networks (DNN), convolutional deep neural networks (CNN), recurrent neural networks (RNN), restricted Boltzmann machine (RBM), deep belief networks (DBN), or Deep Q-Networks, and may be applied to fields such as computer vision, speech recognition, natural language processing, and speech/signal processing.

The processor that performs the functions as described above may be a general-purpose processor (e.g., CPU), but may be an AI dedicated processor (e.g., GPU) for artificial intelligence learning. Moreover, the processor that performs the functions described above may be one or more processors. The memory 147 may store various programs and data required for the operation of the machine learner 145. The memory 147 may be implemented by a non-volatile memory, a volatile memory, a flash memory, a hard disk drive (HDD), a solid state drive (SDD), or the like. The memory 147 may be accessed by the AI processor 141, and data read/write/edit/delete/update by the AI processor 141 may be performed. In addition, the memory 147 may store a neural network model (e.g., a deep learning model 56) generated through a learning algorithm for data classification/recognition in accordance with an exemplary embodiment of the present disclosure.

The AI processor 141 may include a data learner 142 for learning a neural network for data classification/recognition. The data learner 142 may learn a criterion on which training data to use and how to classify and recognize data using the training data in order to determine data classification/recognition. The data learner 142 may learn the deep learning model by acquiring training data to be used for learning and applying the acquired training data to the deep learning model.

The data learner 142 may be manufactured in the form of at least one hardware chip and mounted on the machine learner 145. For example, the data learner 142 may be manufactured in the form of a dedicated hardware chip for artificial intelligence (AI), or may be manufactured as a part of a general-purpose processor (CPU) or a dedicated graphics processor (GPU) and mounted on the machine learner 145. In addition, the data learner 142 may be implemented as a software module. When implemented as a software module (or a program module including an instruction), the software module may be stored in a non-transitory computer-readable medium. In this case, at least one software module may be provided by an operating system (OS) or an application.

The data learner 142 may include a training data acquirer 143 and a model learner 144.

The training data acquirer 143 may acquire training data requested for the neural network model for classifying and recognizing data. For example, the training data acquirer 143 may acquire training data and/or sample data for input into the neural network model as training data.

The model learner 144 may learn to have a criterion for determining how the neural network model classifies predetermined data by using the acquired training data. In this case, the model learner 144 may train the neural network model through supervised learning using at least a portion of the training data as a criterion for determination. Alternatively, the model learner 144 may train the neural network model through unsupervised learning to discover a criterion by self-learning using the training data without being supervised. In addition, the model learner 144 may train the neural network model through reinforcement learning by using feedback on whether the result of situation determination based on the learning is correct. In addition, the model learner 144 may train the neural network model by using a learning algorithm including an error back-propagation method or a gradient decent method.

When the neural network model is trained, the model learner 144 may store the learned neural network model in the memory. The model learner 144 may store the learned neural network model in a memory of a server connected to the machine learner 145 via a wired or wireless network.

The data learner 142 may further include a training data preprocessor and a training data selector in order to improve the analysis result of the recognition model or to save resources or time required for generating the recognition model.

The training data preprocessor may preprocess the acquired data such that the acquired data may be used for learning to determine the situation. For example, the training data preprocessor may process the acquired data into a preset format such that the model learner 144 may use the training data acquired for learning for image recognition.

In addition, the training data selector may select data required for training from the training data acquired by the training data acquirer 143 or the training data preprocessed by the preprocessor. The selected training data may be provided to the model learner 144. For example, the training data selector may select only data on an object included in a specific region as the training data by detecting the specific region among images acquired through a camera.

In addition, the data learner 142 may further include a model evaluation unit to improve the analysis result of the neural network model.

The model evaluator may input evaluation data to the neural network model, and may cause the model learner 144 to retrain the neural network model when an analysis result output from the evaluation data does not satisfy a predetermined criterion. In this case, the evaluation data may be predefined data for evaluating the recognition model. For example, the model evaluator may evaluate the model as not satisfying a predetermined criterion when, among the analysis results of the trained recognition model for the evaluation data, the number or ratio of evaluation data for which the analysis result is inaccurate exceeds a preset threshold.

Referring to FIG. 9B, the deep neural network (DNN) is an artificial neural network (ANN) including several hidden layers between an input layer and an output layer. The deep neural network may model complex non-linear relationships, as in typical artificial neural networks.

For example, in a deep neural network structure for an object identification model, each object may be represented as a hierarchical configuration of basic image elements. In this case, the additional layers may aggregate the characteristics of the gradually gathered lower layers. This feature of deep neural networks may allow more complex data to be modeled with fewer units (nodes) than similarly performed artificial neural networks.

As the number of hidden layers increases, the artificial neural network is called ‘deep’, and machine learning paradigm that uses such a sufficiently deepened artificial neural network as a learning model is called deep learning. Furthermore, the sufficiently deep artificial neural network used for the deep learning is commonly referred to as the deep neural network (DNN).

In one or more embodiments of the present disclosure, data required to train an AI may be input to the input layer of the DNN, and meaningful evaluation data that may be used by a user may be generated through the output layer while the data passes through the hidden layers. In this way, the accuracy of the evaluation data trained through the neural network model may be represented by a probability, and the higher the probability, the higher the accuracy of the evaluated result.

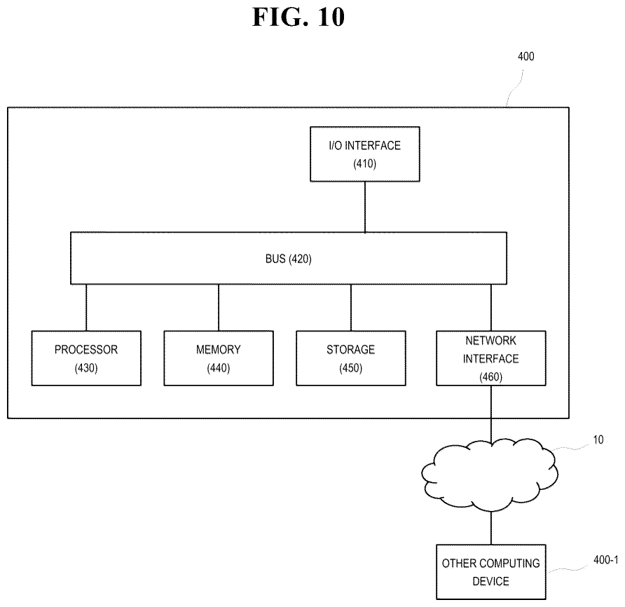

FIG. 10 is a block diagram illustrating the hardware configuration of a computing device that implements a vehicle identity recognition device 100 of FIG. 4.

Referring to FIG. 10, a computing device 400 may include a bus 420, a processor 430, a memory 440, a storage 450, an input/output interface 410, and a network interface 460. The bus 420 may be a path for the transmission of data between the processor 430, the memory 440, the storage 450, the input/output interface 410, and the network interface 460. However, it is not particularly limited how the processor 430, the memory 440, the storage 450, the input/output interface 410, and the network interface 460 are connected. The processor 430 may be an arithmetic processing unit such as a central processing unit (CPU) or a graphics processing unit (GPU). The memory 440 may be a memory such as a random-access memory (RAM) or a read-only memory (ROM). The storage 450 may be a storage device such as a hard disk, a solid state drive (SSD), or a memory card. The storage 450 may also be a memory such as a RAM or a ROM.

The input/output interface 410 may be an interface for connecting the computing device 400 and an input/output device. For example, a keyboard or a mouse may be connected to the input/output interface 410.

The network interface 460 may be an interface for communicatively connecting the computing device 400 and an external device to exchange transport packets with each other. The network interface 460 may be a network interface for connection to a wired line or for connection to a wireless line. For example, the computing device 400 may be connected to another computing device 400-1 via a network 10.

The storage 450 may store program modules that implement the functions of the computing device 400. The processor 430 may implement the functions of the computing device 400 by executing the program modules. Here, the processor 430 may read the program modules into the memory 440 and may then execute the program modules. The processor 430 may perform these functions on one central processor, or the functions may be implemented among a plurality of processors.

The hardware configuration of the computing device 400 is not particularly limited to the configuration illustrated in FIG. 10. For example, the program modules may be stored in the memory 440. In this example, the computing device 400 may not include the storage 450.

The vehicle identity recognition device 100 may at least include the processor 430 and the memory 440, which stores instructions that can be executed by the processor 430. The vehicle identity recognition device 100 of FIG. 4 may be driven by executing instructions including a variety of functional blocks or steps included in the vehicle identity recognition device 100, via the processor 430.

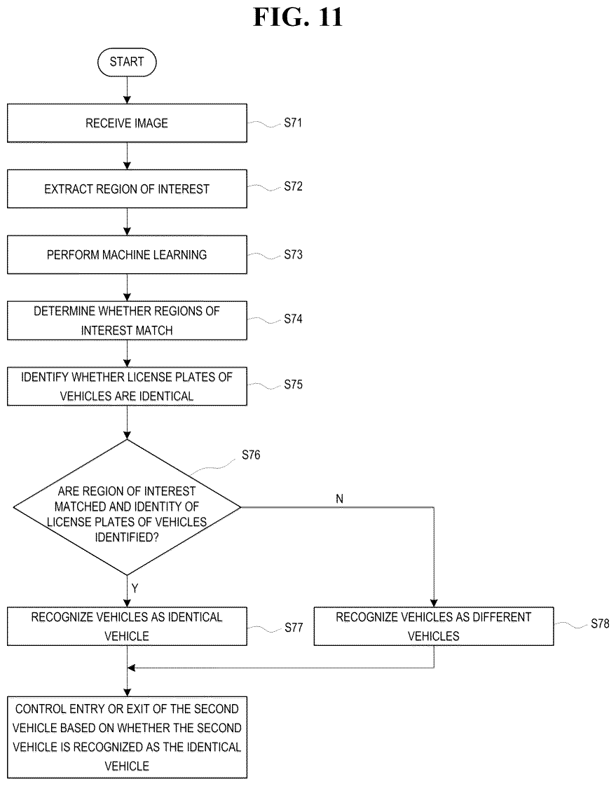

FIG. 11 is a flowchart schematically illustrating a vehicle identity recognition method performed by the vehicle identity recognition device 100 according to an embodiment of the present disclosure.

First, the data input interface 110 may receive a first image including a first vehicle and a second image including a second vehicle (S71).

Next, the region of interest extractor 115 may extract a first region of interest for the input first image and may extract a second region of interest for the second image corresponding to the first region of interest (S72). Here, the first region of interest and the second region of interest may be some regions including at least a vehicle license plate.

The machine learner 145 may input the first region of interest as training data and perform machine learning (S73). In addition, the image matcher 155 may determine whether the first region of interest on which the machine learning was performed matches the second region of interest (S74).

The license plate identifier 125 may identify whether a license plate of the first vehicle and a license plate of the second vehicle are identical (S75).

Next, the controller 150 may determine whether the conditions for matching the regions of interest and the conditions where the license plates of the vehicles are identical are both satisfied (S76). As a result, if the conditions are both satisfied (Y in S76), the controller 150 may recognize the first vehicle and the second vehicle as the identical vehicle (S77). On the other hand, if any of the conditions are not satisfied (N in S76), the controller 150 may recognize the first vehicle and the second vehicle as different vehicles (S78).

Additionally, before step S73, the weight applier 130 may apply different weights to each of the vehicle license plate area and the vehicle license plate external area for at least one of the extracted first region of interest and the extracted second region of interest. In this case, the weight applier 130 may apply a relatively low weight to the vehicle license plate area and applies a relatively high weight to the vehicle license plate external region.

In addition, additionally, after the operation of the weight applier 130, the image scrambler 135 may apply an artificial image change to at least one of the first region of interest and the second region of interest to which the weight is applied. The artificial image change may include one or more of an image brightness change, a contrast change, a blur change, and image tampering.

The feature point extractor 140 may extract feature points for each of the extracted first region of interest and the extracted second region of interest, and may input the feature points into the machine learner 145 as training data.

As used in connection with various embodiments of the disclosure, the term “module” or “unit” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments including, but not limited to, FIGS. 3, 4, 9A and 10, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

According to the present disclosure, the accuracy of the determination may be improved by determining whether the vehicle is identical by considering the vehicle's license plate identification and the unique characteristics of the vehicle image.

Further, according to the present disclosure, when determining whether the vehicle is identical, the accuracy may be improved and the complexity of machine learning may be reduced, thereby enabling rapid identity determination even on a computing device with low system resources.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A vehicle identity recognition device comprising:
a data input interface configured to receive a first image of a first vehicle and a second image of a second vehicle; and
at least one processor configured to control:
a region of interest extractor to extract a first region of interest from the first image and extract a second region of interest from the second image corresponding to the first region of interest, the first region of interest and the second region of interest being partial regions of a vehicle including a vehicle license plate;
a machine learner to perform machine learning by inputting the first region of interest as training data;
an image matcher to determine whether the first region of interest on which the machine learning is performed matches the second region of interest;
a license plate identifier to identify whether a license plate of the first vehicle is identical to a license plate of the second vehicle; and
a controller to recognize the second vehicle as an identical vehicle based on the first region of interest matching the second region of interest and the license plate of the first vehicle being identical to the license plate of the second vehicle.

2. The vehicle identity recognition device of claim 1, wherein the at least one processor is further configured to control:
a weight applier to apply different weights to each of a vehicle license plate area and a vehicle license plate external region for at least one of the first region of interest and the second region of interest.

3. The vehicle identity recognition device of claim 2, wherein a first weight is applied to the vehicle license plate area and a second weight, higher than the first weight, is applied to the vehicle license plate external region.

4. The vehicle identity recognition device of claim 1, wherein the at least one processor is further configured to control:
an image scrambler to apply an artificial image change to at least one of the first region of interest and the second region of interest, and
wherein the artificial image change comprises one or more of an image brightness change, a contrast change, a blur change, and image tampering.

5. The vehicle identity recognition device of claim 1, wherein the at least one processor is further configured to control:
a feature point extractor to extract feature points for each of the extracted first region of interest and the extracted second region of interest,
the machine learner to perform the machine learning based on the extracted feature points as input, and
the image matcher to determine whether the regions of interest are matched based on the extracted feature points.

6. The vehicle identity recognition device of claim 1, wherein the license plate of the first vehicle is a value input by a user, and
wherein the at least one processor is further configured to control the license plate identifier to:
recognize the license plate of the second vehicle by OCR, and
determine whether the license plate of the second vehicle matches the license plate of the first vehicle.

7. The vehicle identity recognition device of claim 1, wherein the at least one processor is further configured to control the license plate identifier to:
convert a license plate included in the first region of interest and a license plate included in the second region of interest into a frontal image, and
determine whether the license plate of the second vehicle matches the license plate of the first vehicle.

8. The vehicle identity recognition device of claim 7, wherein the at least one processor is further configured to control the license plate identifier to:
recognize at least one of a font, an aspect ratio, and a blank ratio of the license plate included in the first region of interest and the license plate included in the second region of interest.

9. The vehicle identity recognition device of claim 1, wherein the at least one processor is further configured to control the image matcher to:
convert the first region of interest on which the machine learning is performed and the second region of interest into images of a same angle, and
determine whether the converted images match.

10. The vehicle identity recognition device of claim 1, wherein the at least one processor is further configured to control:
based on a matching probability between the first region of interest on which the machine learning is performed and the second region of interest being greater than or equal to a reference value, the image matcher to determine that the first region of interest matches the second region of interest.

11. The vehicle identity recognition device of claim 1, wherein the machine learning is at least one of supervised learning and unsupervised learning.

12. The vehicle identity recognition device of claim 1, wherein the at least one processor is further configured to control the machine learner to perform machine learning by inputting the first region of interest as training data for each of three color components.

13. The vehicle identity recognition device of claim 1, wherein the data input interface is further configured to repeatedly receive the first image of the first vehicle a predetermined number of times.

14. The vehicle identity recognition device of claim 1, wherein the at least one processor is further configured to control:
based on a time at which the first vehicle is recognized by a specific camera and a second time at which the second vehicle is recognized by the specific camera being within a predetermined threshold, the controller to recognize the first vehicle and the second vehicle as different vehicles.

15. A vehicle identity recognition method performed by a vehicle identity recognition device including at least one processor and a memory that stores instructions executable by the at least one processor, the vehicle identity recognition method performed by the instructions under the control of the at least one processor, the vehicle identity recognition method comprising:
receiving a first image of a first vehicle and a second image of a second vehicle;
extracting a first region of interest from the first image;
extracting a second region of interest from the second image corresponding to the first region of interest, the first region of interest and the second region of interest being partial regions of a vehicle including a vehicle license plate;
performing machine learning by inputting the first region of interest as training data;
determining whether the first region of interest on which the machine learning is performed matches the second region of interest;
identifying whether a license plate of the first vehicle is identical to a license plate of the second vehicle; and
recognizing the second vehicle as an identical vehicle based on the first region of interest matching with the second region of interest and the license plate of the first vehicle being identical to the second vehicle.

16. The vehicle identity recognition method of claim 15, further comprising:
applying different weights to each of a vehicle license plate area and a vehicle license plate external region for at least one of the first region of interest and the second region of interest.

17. The vehicle identity recognition method of claim 16, further comprising:
applying a first weight to the vehicle license plate area and applying a second weight higher than the first weight to the vehicle license plate external region.

18. The vehicle identity recognition method of claim 15, further comprising:
applying an artificial image change to at least one of the first region of interest and the second region of interest,
wherein the artificial image change comprises one or more of an image brightness change, a contrast change, a blur change, and image tampering.

19. The vehicle identity recognition method of claim 15, further comprising:
extracting feature points from each of the first region of interest and the second region of interest.

20. A vehicle identity recognition device comprising:
a data input interface configured to receive a first image of a first vehicle and a second image of a second vehicle; and
at least one processor configured to control:
a region of interest extractor to extract a first region of interest from the first image and extract a second region of interest from the second image corresponding to the first region of interest, the first region of interest and the second region of interest being partial regions of a vehicle including a vehicle license plate;
an image matcher to determine whether the first region of interest matches the second region of interest;
a license plate identifier to identify whether a license plate of the first vehicle is identical to a license plate of the second vehicle; and
a controller to recognize the second vehicle as the identical vehicle based on the first region of interest matching the second region of interest and the license plate of the first vehicle being identical to the license plate of the second vehicle.

21. The vehicle identity recognition device of claim 1, wherein the at least one processor is further configured to control an entry or an exit of the second vehicle based on whether the second vehicle is recognized as the identical vehicle.

22. The vehicle identity recognition method of claim 15, further comprising:
controlling entry or exit of the second vehicle based on whether the second vehicle is recognized as the identical vehicle.

23. The vehicle identity recognition device of claim 20, wherein the at least one processor is further configured to control entry or exit of the second vehicle based on whether the second vehicle is recognized as the identical vehicle.
